(19) United States
(12) Patent Application Publication
(10) Pub. No.: US 2006/0201646 A1
(43) Pub. Date: Sep. 14, 2006

(54) Aqueous suspension providing high opacity to paper

(75) Inventor: Josep Maria Gussinyer Canadell, Sant Joan de les Fonts (ES)

Correspondence Address: PAUL S MADAN;MADAN, MOSSMAN & SRIRAM, PC, 2603 AUGUSTA, SUITE 700, HOUSTON, TX, 77057-1130, US

(73) Assignee: Savicell SpA, Albizzate (IT)

(21) Appl. No.: 11/431,959

(22) Filed: May 11, 2006

Related U.S. Application Data
(63) Continuation-in-part of application No. 10/221,713, filed on Jan. 10, 2005.

(51) Int. Cl. D21H 17/63; D21H 11/00; D21H 23/00; C04B 28/14; D21H 19/00

(52) U.S. Cl. 162/158; 162/181.1; 162/181.3; 162/181.2; 162/181.4; 162/181.6; 162/181.8; 106/773; 106/782; 106/788; 106/772; 106/780; 106/164.51; 106/164.53

(57) ABSTRACT

The addition of small quantities of at least one additive to calcium sulfate prior to addition of the calcium sulfate to the cellulose fiber solution for paper manufacture has been found to significantly increase its opacifying capacity. Suitable additives for this invention include: kaolin, calcium carbonate, talc, titanium dioxide, aluminum silicate, calcium silicate, other silicates and/or their mixtures.

### CROSS REFERENCES TO RELATED APPLICATIONS

This application is a continuation in part of the U.S. Patent Application having the Ser. No.10/221,713 filed Sep. 13, 2002, titled “Aqueous Suspension Providing High Opacity To Paper”, which is hereby fully incorporated by reference herein.

### BACKGROUND OF THE INVENTION

1. Field of the Invention

This invention concerns the field of paper manufacture and refers to an aqueous suspension for addition to cellulose fiber paste, in which such suspension includes n hydrated calcium sulfate plus at least one additive.

The addition of this aqueous suspension to the cellulose fiber paste during the paper preparation process causes a surprising increase in the opacifying capability of calcium sulfate.

2. Background of the Art

In paper-making processes currently existing in the state of the art, different additives are normally added to the aqueous suspension of cellulose in order to give it the desired characteristics (physical and mechanical resistance values etc.). Nevertheless, the amount of additives employed in relation to the amount of cellulose cannot exceed a certain threshold.

In the state of the art, a great number of documents describe paper preparation processes: DE 3306473 (where a filler combination for the preparation of paper or cardboard type material comprising a calcium silicate with differing degrees of hydration is described); WO 93/02963 (where a filler combination for preparing paper which contains dehydrated calcium sulfate and titanium bioxide and which is prepared by addition of a calcium carbonate dilution to a mixture which contains sulphuric acid, titanium bioxide and iron oxide, is described), and the like.

In the state of the art, the addition of calcium sulfate to the aqueous cellulose fiber suspension during the paper-making state is known to give certain properties to the final product. The designation of calcium sulfate covers any compound that has the general formula of CaSO₄ n H₂O, where n is the number of moles and has a value ranging between 0 and 2 or even higher.

These properties are generally related to greater physical and mechanical resistance of paper, lower energy consumption, better performance of the filler (added inorganic compounds such as additives), lower consumption of cellulose paste, and the like.

Nevertheless, calcium sulfate has a low paper-opacifying capacity and, therefore, the addition of calcium sulfate to the cellulose fiber suspension during paper preparation, even at quantities above 30% by weight, does not sufficiently opacify the paper thus obtained to make it particularly suitable for printing. In other words, maximum amount of calcium sulfate that can be added with respect to the amount of cellulose is not enough to give paper a sufficiently high degree of opacity.

When considering the large amount of paper used for printing and writing, in particular in publications, press uses, notebooks and books for school use and other similar purposes, it is evident that paper opacification is a significant problem.

The low opacifying capacity of paper containing calcium sulfate is the main reason that manufacturers of paper for printing and writing in general add substances such as titanium dioxide with greater opacifying capacity than calcium sulfate to the paste used to manufacture paper. Nevertheless these highly opacifying additives are mostly (as is the case of titanium bioxide) and noticeably increase the cost of paper obtained in this way.

Hence, the need to find a less costly solution to the problem of paper opacification can be easily understood.

### SUMMARY OF THE INVENTION

Surprisingly, this invention, the addition of small quantities of at least one additive to calcium sulfate prior to addition of the calcium sulfate to the cellulose fiber solution for paper manufacture has been found to significantly increase its opacifying capability. Suitable additives for this invention include: kaolin, calcium carbonate, talc, titanium dioxide, aluminum silicate, calcium silicate, other silicates and/ortheir mixtures, as described below.

### DETAILED DESCRIPTION

This invention refers to an aqueous suspension for addition to the cellulose fiber paste used in paper-making, in which the suspension includes n hydrated calcium sulfate (CaSO₄ nH₂O), where n has a value ranging between 0 and 2 (0<n<2) and an additive.

Suitable additives for this invention are, for example: kaolin, calcium carbonate, talc, titanium dioxide, aluminum silicate, calcium silicate, other silicates and/or their mixtures.

Due to the variety of compounds that show suitable behavior in an aqueous suspension according to this invention, the additives indicated here should only be considered as examples and the invention is not limited to use of these alone.

This invention also refers to a process used to prepare this aqueous suspension that consists of n hydrated calcium sulfate and one additive.

This invention also refers to a process to obtain paper that includes the preparation of this aqueous suspension that contains n hydrated calcium sulfate where n is between 0 and 2 and at least one additive, and the addition of this suspension to the aqueous cellulose fiber suspension used to manufacture paper.

In this invention, calcium sulfates with differing degrees of hydration can be used, except for natural anhydrous calcium sulfate. There are two kinds of calcium sulfates with n=0: natural anhydrous and artificial anhydrous. Natural calcium sulfate anhydrous, which is found in quarries mixed with calcium sulfate with n=2, cannot be used in a suspension according to this invention. In contrast, artificial calcium sulfate anhydrous, which comes from calcium sulfate dihydrate that has been heated to remove 2 moles of water, can be used in this invention, requiring simply more time and a higher stirring speed to obtain an aqueous suspension according to the invention.

Without intending to limit the scope of this invention in any way, it is postulated that when at least one of these additives is mixed with n hydrated calcium sulfate (where n has a value ranging between 0 and 2) in water, this additive is included in the crystalline structure of calcium sulfate modifying the percentage of reflected and/or refracted light rays and therefore modifying the opacifying capacity of this calcium sulfate.

The structural modification of calcium sulfate crystals does not occur if the additive is added in the presence of the aqueous cellulose fiber suspension. It is postulated that the cellulose rapidly attracts calcium sulfate, thereby preventing any possible transformation of the properties of the calcium sulfate crystals.

The addition of additives of the kaolin, calcium carbonate, talcum, titanium dioxide, aluminum silicate or calcium silicate type to the aqueous cellulose fiber suspension during paper-making is well known in the state of the art. Nevertheless, it is important to stress that in the state of the art, there is no description or suggestion that the combined use of n hydrated calcium sulfate, where n has a value ranging between 0 and 2, together with at least one additive prior to the addition to the cellulose fiber suspension would cause a significant increase in the opacifying capacity of calcium sulfate. This increase does not result simply from the sum of the opacifying capacities of calcium sulfate and the additive, but rather from a modification of the crystalline structure of calcium sulfate, which causes an opacifying effect that is surprisingly higher than expected.

In an aqueous suspension according to this invention, n hydrated calcium sulfate (CaSO₄nH₂O), and the additive(s) are found at a ratio by weight between 100:1 and 1:1, preferably between 50:1 and 2:1.

In an aqueous suspension according to this invention, the ratio between the mixture of n hydrated calcium sulfate and the additive(s) with respect to water ranges between 0.1% and 80% by weight, preferably between 1% and 25% by weight.

In an aqueous suspension according to this invention, the optimal pH value of this suspension ranges between 3 and 9, preferably between 4 and 8.

This invention also refers to a process used to prepare an aqueous suspension that includes n hydrated calcium sulfate, where n is between 0 and 2 (0<n<2) and at least one additive according to the invention. This process consists of 1) mixing this calcium sulfate and at least one of these additives with water; and 2) homogenising the mixture by stirring vigorously.

In a preferred application of this application, this calcium sulfate and this additive are mixed together while still dry, before being mixed with water. In another preferred application of the invention, this calcium sulfate and this additive are added to water separately.

This invention also refers to a process used for paper-making, in which the process is characterized in that a previously prepared aqueous suspension of at least one additive and n hydrated and calcium sulfate is added to the cellulose fiber solution. This process consists of the following steps: 1) Preparation of a suspension according to the invention as described above; 2) Preparation of a cellulose fiber suspension in water; and 3) Addition of suspension according to the invention to the cellulose fiber suspension in the paper circuit.

In a paper-making process using an aqueous suspension according to this invention, the calcium sulfate and at least one of these additives is kept under suspension by stirring until the time the cellulose paste is added. The stirring time depends on the kind of n hydrated calcium sulfate used and the kind of additive(s) and is, in general, equal to or greater than 30 minutes.

As an advantage, the paper-making process according to this invention allows highly opaque paper to be obtained at a low cost.

As another advantage, the process of the invention can be used directly in a paper making application. In the prior art, some additives is not suited as such for use in paper manufacture as is, but requires a separation process to, for example, remove colored compounds. In such a process, the precipitated product must be separated from the reaction mass because the aqueous phase still contains iron salts and is coloured. In the practice of the present invention, the aqueous suspension may be used “as is” in the substantial absence of a separation process for the removal of colored compounds.

An illustrative, non-limiting example of the invention is given below.

### EXAMPLES

The batch of n hydrated calcium sulfate used specifically in the following tests is CaSO₄×0.3 H₂O (i.e., n=0.3 moles). When this calcium sulfate is added along with at least one additive in water to create an aqueous suspension according to this invention, this compound is hydrated to a greater or lesser extent, depending on the value of n.

This the tests described below, a stirring speed of 3000 rpm and a stirring time of 30minutes were used, with calcium sulfate hydrated with n=0.3. Technical characteristics of the products used in the test:

Kaolin

GRANULOMETRY = 88-90% <2 μm

Talcum

GRANULOMETRY = 25% <μm and without residue filtrate at 50 μm

CaCO₃
ANALYSIS (%)

| | |
|---|---|
| CaCO₃ | >99 |
| SiO₂ | 0.4 |
| MgO | 0.3 |
| Al₂O₃ | 0.1 |
| Fe₂O₃ | 0.08 |
| SO₄ | <0.1 |

GRANULOMETRY (% particles with a size smaller than:)

| | |
|---|---|
| 60μ | 99 |
| 40μ | 95 |
| 20μ | 83 |
| 5μ | 38 |

| | | |
|---|---|---|
| PROPERTIES | FMX-AMBAR filter | 88.6 |
| WHITENESS: | FMY-Green filter | 87.1 |
| FMZ-Blue filter | 80.6 | |

Anastasa titanium bioxide

| | |
|---|---|
| TiO₂ | 98.0% |
| Fe₂O₃ | 0.1% max |
| SiO₂ | 0.5% max |
| SO₃ | 0.5% max |
| P₂O₅ | 0.5% max |

GRANULOMETRY

Residue on sieve 325 mesh (44 μm); <0.5%

Calcium sulfate n = 0.3

| | |
|---|---|
| Reject sieve at 53 microns | 0.39% |
| Whiteness Z % Hunterlab | 92.3% |
| Yellow index ASTM E313 | 2.1 |
| Initial setting time | 9 min |

### Example 1.

### Preparation of fillers at 10% concentration in weight

Three different kinds of filler were prepared:

a) Calcium sulfate dihydrate

90% of CaSO4 saturated water and 10% of CaSO₄×2 H₂O =90% of CaSO4 saturated water and (8.2% of CaSO₄×0.3 H₂O and 1.8% H₂O)=91.8% of CaSO4 saturated water and 8.2% of CaSO₄×0.3 H₂O

b) Additive (talcum, calcium carbonate, kaolin or titanium dioxide)

90% deionized water and 10% additive

c) Calcium sulfate and additive.

90% CaSO₄ saturated water and 9% CaSO₄×2 H₂0 and 1 % additive or additive mixture equal to 90% water and (7.4% CaSO₄×0.3 H₂0 and 1.6% H₂O=9% of CaSO₄ 2H₂O) and 1% additive equal to 91.6% water and 7.4% CaSO₄×0.3 H₂0 and 1% additive.

To prepare the suspensions, CaSO₄0.3 H₂O and/or the additive are gradually added over the water while stirring at 3000 rpm, and stirring is continued for at least 30 minutes before the suspension is added to the fiber suspension.

### Example 2.

### Preparation of paper

1. A cellulose dispersion at a concentration of 1±0.01 % (dry) is prepared. A bleached sulfate cellulose paste is used as the starting material, as in the case of all tests.

a) In all tests where the filler contains calcium sulfate, water saturated-calcium sulfate is used to prepare this dispersion. Water-saturated calcium sulfate has a conductivity of 1.42mS.

b) In tests where the filler does not contain calcium sulfate, dionized water is used to prepare this dispersion.

The dispersion is prepared in a “pulper” or laboratory disintegrator for 2 hours.

2. Samples of the prepared solution are collected using a standard container to ensure that the same quantity of dispersed paste at 1±0.01% is collected at all times. This quantity is 37.478 g.

3. A second dilution of the cellulose paste is made by homogenizing the 37.478 g of paste at 1 % with 400 g of water:

a) Saturated with calcium sulfate in tests where the filler contains calcium sulfate.

b) Deionized water in all other cases.

The dilution is carried out in a magnetic laboratory stirrer apparatus at 1100 rpm for 40 sec.

4. Immediately after the stirrer is turned on, one of the fillers prepared in Example 1 is added.

Two different tests are conducted for each kind of filler: addition of 30% or 15% of filler, calculated with respect to the cellulose.

Addition of 30% calculated with respect to the cellulose: 1.124 g of filler at 10% are added

37.478 g of cellulose at 1%=0.37478 g of cellulose (dry).

0.37478×30/100=0.1124 g filler (dry), i.e., 1.124 g of filler at 10%; which represents 23.1 % of filler with respect to the total solids.

Addition of 15% calculated with respect to the cellulose: 0.562 g of filler at 10% are added.

37.478 g of cellulose at 1%=0.37478 g of cellulose (dry).

0.37478×15/100=0.0562 g filler (dry), i.e., 0.562 g of filler at 10%; which represents 11.55% of filler with respect to the total solids.

5. After 40 sec, the stirrer is turned off and the dispersion is filtered through a Buchner funnel under vacuum conditions.

The filter used is a cellulose triacetate membrane of pore size of 0.2 microns, sufficiently small to prevent losses.

Once the dispersion is filtered, the filter and paper sheet are removed with Buchner tongs and the dispersion is placed in an oven at 80° C. with forced air circulation until the weight is constant.

6. The dry paper sheet and filter is weighed and the opacity of the entire unit is checked in a photovolt apparatus.

Both the prepared sheet of paper and the filter have a diameter of 9.20 cm. The opacity of the unit is measured at 5 different points on the circumference: at the midpoint and at 4 points at a distance equally apart from each other that is equivalent to half the distance between the midpoint of the sheet and the circumference perimeter.

Once the 5 results have been obtained, the mean of all 5 results is computed. If any of the results vary more than 10% from the mean, the 5 results of this sheet are discarded.

To calculate the opacity of the paper prepared using the process according to the invention described above, the difference between the total opacity (of the sheet of paper and filter) and the filter opacity must be calculated.
[Op(P+F)]−(Op F)=Op P
Op(P+F)-opacity of paper and filter
OP F=opacity of the filler
Op P=opacity of the sheet of paper.

### RESULTS

A) From the group of additives

Two different tests are performed foreach additive (with 30% and 15% of fillerwith respect to cellulose).

| PRODUCT | OPAC. with 30% | OPAC. with 15% |
|---|---|---|
| Talc | 8.76° | 7.9° |
| Calcium carbonate | 12.25° | 10.2° |
| Calcium Sulfate | 14.4° | 12.0° |
| Kaolin | 16.2° | 13.0° |
| TiO₂ | 19° | 17.0° |

B) Aqueous suspension of calcium sulfate and additive added to the cellulose fiber suspension

| Calcium sulfate and additive | OPAC. with 30% | OPAC. with 15% |
|---|---|---|
| 10% calcium sulfate | 14.4° | 12° |
| 9% calcium sulfate and 1% Talc | 15.6° | 14.3° |
| 9% calcium sulfate and 1% | 15.1° | 13.6° |
| Calcium carbonate | | |
| 9% calcium sulfate and 1% kaolin | 17.6° | 17.0° |
| 9% calcium sulfate and 1% TiO₂ | 18.3° | 17.4° |

C) Calcium sulfate and additive added separately to the cellulose fiber suspension.

| Calcium sulfate and additive | OPAC. with 30% | OPAC. with 15% |
|---|---|---|
| 9% calcium sulfate | 13.7° | 11.5° |
| 9% calcium sulfate and 1% Talc | 14.3° | 11.8° |
| 9% calcium sulfate and 1% kaolin | 14.7° | 11.9° |
| 9% calcium sulfate and 1% TiO₂ | 14.8° | 12.5° |
| 10% calcium sulfate | 14.4° | 12° |

### DISCUSSION OF THE RESULTS

The following table shows the increased opacifying capacity of calcium sulfate when this calcium sulfate is prepared and added in combination with one additive (in the case of 30% of filler, calculated with respect to dry cellulose).

| | OPACITY With 30% | Increase with |
|---|---|---|
| | Prepared and added | respect to calcium |
| | together | sulfate only |
| 10% calcium sulfate | 14.4° | |
| 9% sulfate and 1% talc | 15.6° | 8.3% |
| 9% sulfate and 1% CaO₃ | 15.1° | 4.9% |
| 9% sulfate and 1% kaolin | 17.6° | 22.2% |
| 9% sulfate and 1% TiO₂ | 18.3° | 27.1% |

By comparing the results, the addition of n hydrated calcium sulfate and one additive separately to the fiber suspension is seen not to produce any particular increase in opacity, whereas if a previously prepared suspension of n hydrated calcium sulfate and additive is added to the cellulose fiber suspension, a surprising increase in the opacity of calcium sulfate is observed.

What is claimed is:

1. An aqueous suspension for addition to a cellulose fiber paste used in the manufacture of paper consisting essentially of:
calcium sulphate n hydrated (CaSO₄×nH₂O);
an additive selected from the group consisting of kaolin, calcium carbonate, talc, titanium dioxide, aluminum silicate, calcium silicate, magnesium silicate, other silicates and/or their mixtures;
wherein the calcium sulphate and the additive are present at a weight ratio ranging between 100:1 and 1:1;
wherein n has a value ranging between 0 and 2; and
wherein a ratio between the calcium sulphate n hydrated and the additive with respect to water ranges between 0.1% and 80% by weight.

2. The aqueous suspension according to claim 1, wherein the calcium sulphate and the additive are present at a weight ratio ranging between 50:1 and 2:1.

3. The aqueous suspension according to claim 1, wherein the ratio between the calcium sulphate n hydrated and the additive with respect to water ranges between 1% and 50% by weight.

4. A process for the preparation of an aqueous suspension for addition to a cellulose fiber paste used in the manufacture of paper, the process consisting essentially of the steps of:
mixing calcium sulphate n hydrated (CaSO₄ nH₂O) and at least one additive selected from the group consisting of consisting of kaolin, calcium carbonate, talc, titanium dioxide, aluminum silicate, calcium silicate, magnesium silicate, and other silicates;
wherein the calcium sulphate and the additive are present at a weight ratio ranging between 100:1 and 1:1;
wherein n has a value ranging between 0 and 2;
wherein a ratio between the mixture of calcium sulphate n hydrated and the additive with respect to water ranges between 0.1% and 80% by weight; and
homogenizing the mixture while stirring vigorously for a time equal to or greater than thirty minutes.

5. The process according to claim 4, wherein the calcium sulphate n hydrated and the additive are present at a weight ratio ranging between 50:1 and 2:1.

6. The process according to claim 5, wherein the ratio between the mixture of calcium sulphate n hydrated and the additive with respect to water ranges between 1% and 50% by weight.

7. A process for paper making consisting essentially of the steps of: preparing an aqueous solution using a process comprising the steps of:
mixing calcium sulphate n hydrated (CaSO₄ nH₂O) and one additive selected from the group consisting of consisting of kaolin, calcium carbonate, talc, titanium dioxide, aluminum silicate, calcium silicate, magnesium silicate, other silicates and/or their mixtures;
wherein the calcium sulphate and the additive are present at a weight ratio ranging between 100:1 and 1:1;
wherein n has a value ranging between 0 and 2;
wherein a ratio between the mixture of calcium sulphate n hydrate and the additive with respect to water ranges between 0.1% and 80% by weight; and
homogenizing the mixture while stirring vigorously for a time equal to or greater than thirty minutes and keeping it under suspension by stirring; preparing a cellulose fiber suspension in water within a paper circuit; and adding the aqueous solution to the cellulose fiber suspension.

8. The process of claim 7 further comprising adding the aqueous suspension to a cellulose fiber paste to prepare a cellulose fiber suspension.

9. A process for making paper having improved opacity comprising:
1) admixing water, calcium sulfate, and an additive selected from the group consisting of kaolin, calcium carbonate, talc, titanium dioxide, aluminum silicate, calcium silicate, magnesium silicate, other silicates and mixtures thereof, to prepare an aqueous suspension;
2) admixing water and cellulose to prepare a cellulose fiber paste; and
3) admixing the aqueous suspension and the cellulose fiber paste to prepare a cellulose fiber suspension.
